(19) United States
(12) Patent Application Publication
(10) Pub. No.: US 2023/0189215 A1
(43) Pub. Date: Jun. 15, 2023

(54) SYSTEM AND METHOD FOR DRX CONFIGURATION

(71) Applicant: ZTE CORPORATION, Shenzhen (CN)

(72) Inventors: Wenting LI, Shenzhen (CN); He HUANG, Shenzhen (CN)

(73) Assignee: ZTE CORPORATION, Shenzhen (CN)

(21) Appl. No.: 18/167,414

(22) Filed: Feb. 10, 2023

Related U.S. Application Data
(63) Continuation of application No. PCT/CN2020/109142, filed on Aug. 14, 2020.

(51) Int. Cl. H04W 68/02; H04W 52/02

(52) U.S. Cl. CPC H04W 68/02; H04W 52/0229

(57) ABSTRACT

A system and method for configuring a radio resource configuration for different types of Reduced Capability User Equipment in order to achieve different power saving requirements. The system and method includes transmitting, by a wireless communication node, a signal to a plurality of wireless communication devices of different device types. In some embodiments, the signal includes a plurality of associations between a plurality of device types and a plurality of network types, each association of the plurality of associations is indicative of a radio resource configuration for a respective device type of the plurality of device types.

### CROSS-REFERENCE TO RELATED APPLICATION

This application claims the benefit of priority under 35 U.S.C. § 120 as a continuation of PCT Patent Application No. PCT/CN2020/109142, filed on Aug. 14, 2020, the disclosure of which is incorporated herein by reference in its entirety.

### TECHNICAL FIELD

The disclosure relates generally to wireless communications and, more particularly, to systems and methods for configuring a radio resource configuration (e.g., DRX/eDRX) for different types of Reduced Capability User Equipment (UE) in order to achieve different power saving requirements.

### BACKGROUND

The 3rd Generation Partnership Project (3GPP), which has developed the most successful standard technologies in the mobile communication market such as Universal Mobile Telecommunication System (UMTS) and Long Term Evolution (LTE), is currently carrying out the standardization of Fifth Generation (5G) mobile communication technology. Within 3GPP, Service and System Aspects Working Group 2 (SA2) is responsible for identifying the main functions and entities of the network.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In one aspect, a method includes transmitting, by a wireless communication node, a signal to a plurality of wireless communication devices of different device types, wherein the signal comprises a plurality of associations between a plurality of device types and a plurality of network types, each association of the plurality of associations is indicative of a radio resource configuration for a respective device type of the plurality of device types.

In another aspect, a method includes receiving, by a wireless communication device, a signal from a wireless communication node, wherein the signal comprises a plurality of associations between a plurality of device types and a plurality of network types, each association of the plurality of associations is indicative of a radio resource configuration for a respective device type of the plurality of device types, wherein the signal is transmitted to a plurality of wireless communication devices of different device types.

In another aspect, a method includes receiving, by a wireless communication node, capability information indicative of a capability of a wireless communication device to support battery status reporting; requesting, by the wireless communication node via a first message, the wireless communication device to report battery status information; and receiving, by the wireless communication node via a second message, the battery status information from the wireless communication device.

In another aspect, determining, by a wireless communication node, a change in system information; determining, by the wireless communication node, a subset of a plurality of wireless communication devices that are affected by the change in system information; and transmitting, by the wireless communication node, an indication of one or more device types corresponding to the subset of the plurality of wireless communication devices.

The above and other aspects and their embodiments are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure.

FIG. 2 illustrates block diagrams of an example base station and a user equipment device, in accordance with some embodiments of the present disclosure.

FIG. 3 illustrates block diagrams of an example environment for configuring a radio resource configuration per UE device type and/or per network, in accordance with some embodiments of the present disclosure.

FIG. 4 illustrates an example structure for a DownlinkConfigCommonSIB message, in accordance with some embodiments of the present disclosure.

FIG. 5 illustrates an example table showing the different UE types corresponding to the CAG1/CAG2, in accordance with some embodiments of the present disclosure.

FIG. 6 illustrates an example table showing the SI change indication and public warning system (PWS) notification, in accordance with some embodiments of the present disclosure.

FIG. 7 illustrates an example table showing the modification period according to a UE type, a default paging cycle, and system information, in accordance with some embodiments of the present disclosure.

FIG. 8 illustrates an example table showing the bits of a paging message, in accordance with some embodiments of the present disclosure.

FIG. 9 illustrates an example table showing the bits of a paging message, in accordance with some embodiments of the present disclosure.

FIG. 10 illustrates an example table showing the bits of a paging message, in accordance with some embodiments of the present disclosure.

FIG. 11 illustrates an example structure for a LoggedMeasurementCofiguration message, in accordance with some embodiments of the present disclosure.

FIG. 12 illustrates an example structure for a short message for indicating the affected UE Types, in accordance with some embodiments of the present disclosure.

FIG. 13 illustrates an example structure for a short message for indicating the affected UE Types, in accordance with some embodiments of the present disclosure.

FIG. 14 is a flow diagram depicting a method for configuring a radio resource configuration for different types of Reduced Capability UE in order to achieve different power saving requirements, in accordance with some embodiments of the present disclosure.

FIG. 15 is a flow diagram depicting a method for configuring a radio resource configuration for different types of Reduced Capability UE in order to achieve different power saving requirements, in accordance with some embodiments of the present disclosure.

### DETAILED DESCRIPTION OF EXEMPLARY EMBODIMENTS

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The following acronyms are used throughout the present disclosure:

3GPP 3rd Generation Partnership Project

5G 5th Generation Mobile Networks

5G-AN 5G Access Network

5G gNB Next Generation NodeB

CAG Closed Access Group

CCA Clean Channel Access

CCE Control Channel Element

CDRX Connected Mode Discontinuous Reception

CE Control Element

CG Configured Grant

COT Channel Occupancy Time

DCI Downlink Control Information

DG Dynamic Grant

DL Down Link or Downlink

DRX Discontinuous Reception Cycle

eDRX Extended DRX

eMBB Enhanced Mobile Broadband

eNB Evolved Node B

ETSI European Telecommunications Standards Institute

LBT Listen Before Talk/Listen Before Send

LTE Long Term Evolution

MAC Medium Access Control

MBMS Multimedia Broadcast Multicast Service

MBS Multicast and Broadcast Service

MDT Minimum Drive Test

MNO Mobile Network Operator

MSC Mobile Switching Center

NACK Negative Acknowledgement

NAS Non-Access Stratum

NR Next Generation RAN

OFDM Orthogonal Frequency-Division Multiplexing

OFDMA Orthogonal Frequency-Division Multiple Access

OSI Open Systems Interconnection

PDCP Packet Data Convergence Protocol

PNI-NPN Public Network Integrated Non-Public Network

RAN Radio Access Network

RLC Radio Link Control

RNTI radio Network Temporary Identifier

RRC Radio Resource Control

RV Redundancy Version

SNPN Stand-alone Non-Public Network

SFN System Frame Number

UE User Equipment

UL Up Link or Uplink

Reduced Capability UE was introduced in 3GPP Rel-17. According to this standard, there are three different RedCap UE types—industry sensors, video surveillance, and wearable devices—each having different battery life requirements. For the industry sensors, for example, the battery should last at least a few years. Serving as the main power saving method, the Network can configure a radio resource e configuration for the UE in order to allow the UE to sleep periodically. For example, a radio resource configuration may include a discontinuous reception/extended discontinuous reception (DRX/eDRX).

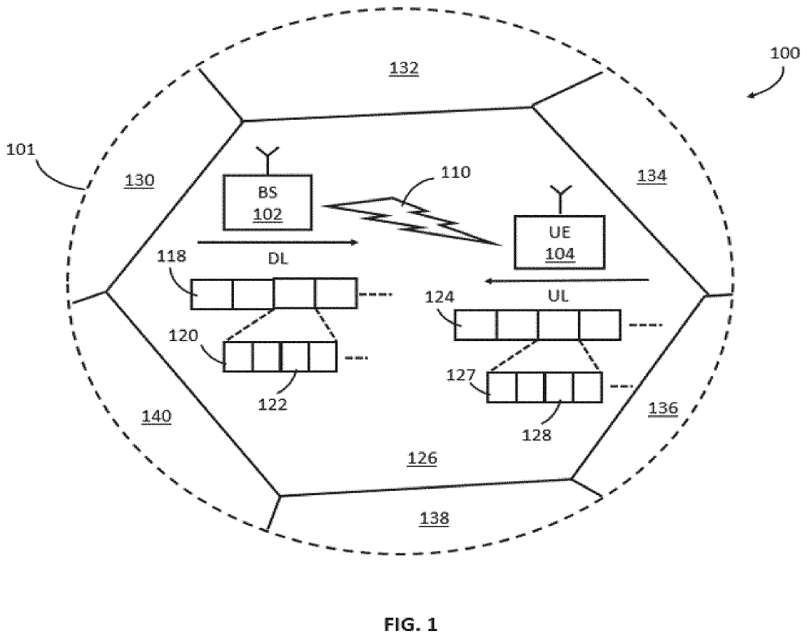

However, in the current design, one cell (e.g., BS 102 in FIG. 1, a network, etc.) cannot configure different radio resource configurations for different device types. Thus, a mechanism is needed for configuring different radio resource configurations for the three different RedCap UE types supported by 3GPP Rel-17.

Furthermore, the non-public network (NPN) is discussed in 3GPP WI16, for the public network integrated NPN (PNI-NPN), which was deployed by the public mobile network operator (MNO). According to this standard, the public MNO should provide one or more interfaces for the customer for performing an authorized network control or a configuration according to their agreements. For example, a customer may want to configure a radio resource configuration (e.g., a long eDRX cycle) for their redCap device. Thus, a mechanism is needed for configuring a radio resource configuration per PNI-NPN and/or per UE device type.

Accordingly, the systems and methods discussed herein provide a mechanism for configuring different radio resource configurations for the three different RedCap UE types supported by 3GPP Rel-17. The systems and methods discussed herein also provide a mechanism for configuring radio resource configurations per PNI-NPN and/or per UE device type.

### 1. Mobile Communication Technology and Environment

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

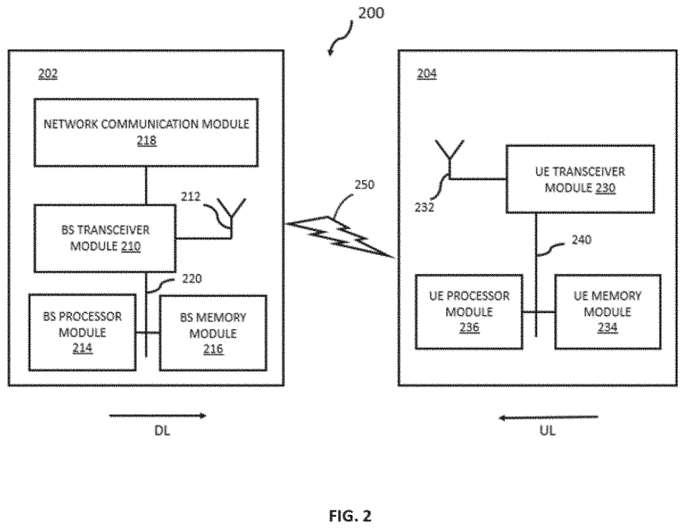

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

2. Configuring a Radio Resource Configuration per UE Device Types and/or Network

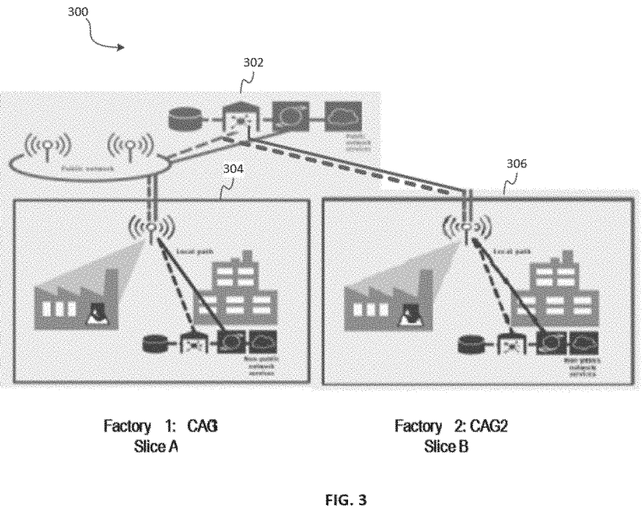

FIG. 3 illustrates block diagrams of an example environment for configuring a radio resource configuration per UE device type and/or per network, in accordance with some embodiments of the present disclosure. The environment 300 may include a public land mobile network (PLMN) 302 (sometimes referred to as, “PLMN1”). The environment 300 may include a Factory 1 corresponding to a closed access group 1 (CAG1) 304. The CAG1 304 may correspond to a first network slice (shown in FIG. 3 as, “Slice A”). The environment 300 may include a Factory 2 corresponding to a closed access group 2 (CAG2) 406. The CAG2 306 may correspond to a second network slice (shown in FIG. 3 as, “Slice A”).

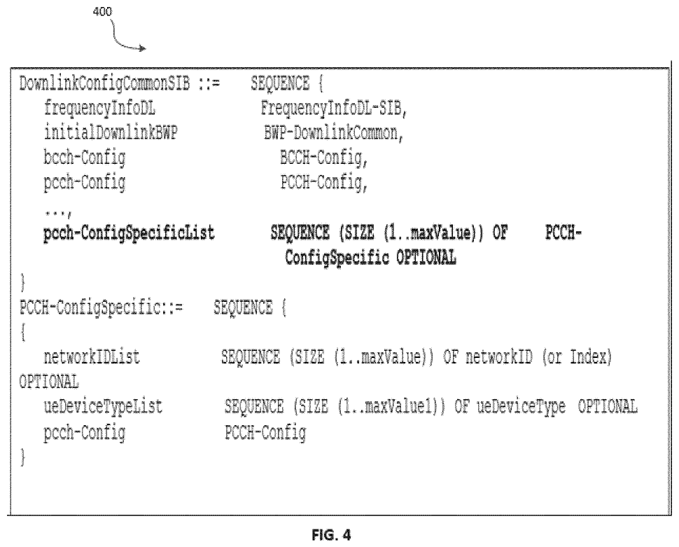

A cell (e.g., BS 102 in FIG. 1, a network, PLMN 302 in FIG. 3, etc.), in some embodiments, may configure (e.g., initialize, adjust, etc.) a radio resource configuration (e.g., eDRX/DRX) per UE device type (e.g., industry sensors, video surveillance, and wearable devices) and/or per network in the system information and/or in a radio resource control (RRC) signal. For example, FIG. 4 illustrates an example structure for a DownlinkConfigCommonSlB message, in accordance with some embodiments of the present disclosure.

### 2.1 Broadcasting the DRX/eDRX Configuration Information

The cell, in some embodiments, can broadcast (e.g., transmit, send, etc.) the radio resource configuration (e.g., DRX/eDRX) according to the structure 400.

The cell, in some embodiments, may be shared by a PLMN1/PLMN1+CAG1/PLMN1+CAG2. The PLMN1, in some embodiments, may be deployed from the Public UE (e.g., UE 104 in FIG. 1). In some embodiments, PLMN1+CAG1 may be deployed by the Factory 1, where a 3GPP operator may create a separate slice for the customer (e.g., sometimes referred to as, “Slice A”). In some embodiments, PLMN1+CAG2 may be deployed by Factory 2, where a 3GPP operator may create a separate slice for the customer (e.g., sometimes referred to as, “Slice B”).

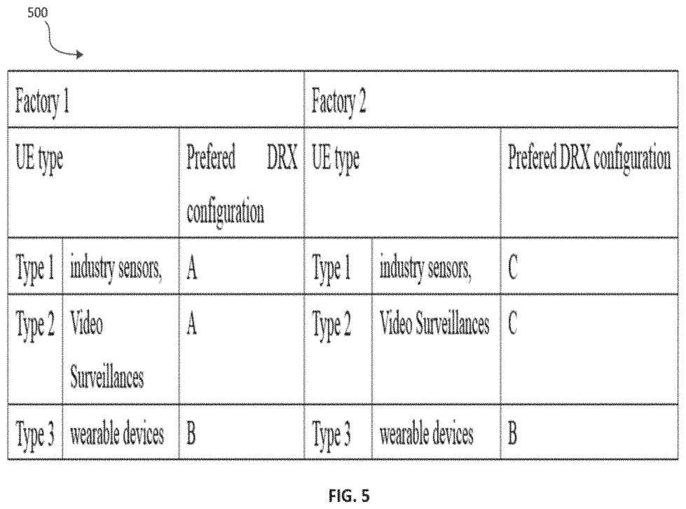

FIG. 5 illustrates an example table showing the different UE types corresponding to the CAG1/CAG2, in accordance with some embodiments of the present disclosure. Per Factory 1, a UE of Type 1 (industry sensors) may correspond to a preferred DRX configuration of ‘A’; a UE of Type 2 (video surveillances) may correspond to a preferred DRX configuration of ‘A’; and/or a UE of Type 3 (wearable devices) may correspond to a preferred DRX configuration of ‘B’.

Per Factory 2, a UE of Type 1 (industry sensors) may correspond to a preferred radio resource configuration (e.g., DRX) of ‘C’; a UE of Type 2 (video surveillances) may correspond to a preferred radio resource configuration (e.g., DRX) of ‘C’; and/or a UE of Type 3 (wearable devices) may correspond to a preferred radio resource configuration (e.g., DRX) of ‘B’.

In some embodiments, a pcch-ConfigSpecificList[0] may correspond to {under the network of the PLMN+CAG1, UEType 1 and UE type 2 was configured with pcch-Config A}. In some embodiments, a pcch-ConfigSpecificList[1] may correspond to {PLMN+CAG1/under the network of PLMN+CAG the UEType 3 was configured with pcch-Config B}. In some embodiments, a pcch-ConfigSpecificList[2] may correspond to {under the network of the PLMN+CAG2: UEType 1+UE type2 was configured with pcch-Config C}.

### 3. Monitoring Changes in System Information

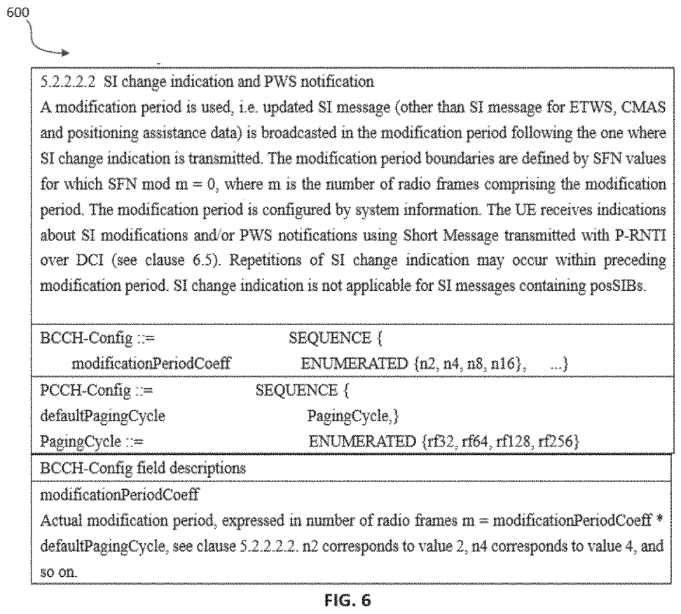

The embodiments below describe how a network and/or customer may monitor changes (e.g., variations, modifications, deviations, adjustments, etc.) in system information. In the legacy scheme, the modification period is determined based on the paging cycle that is broadcasted in the system information. For example, FIG. 6 illustrates an example table showing the SI change indication and public warning system (PWS) notification, in accordance with some embodiments of the present disclosure.

However, different UE types and/or Networks may configure the different paging cycles. The modification period also may be different for different system information elements. As such, the legacy scheme does not provide a mechanism for determining the modification period to account for theses realistic scenarios.

To address this problem, the network should be allowed to configure different modification periods for the different system information and/or the different system information elements.

To achieve this purpose, in some embodiments, the cell (e.g., BS 102 in FIG. 1, a network, PLMN 302 in FIG. 3, etc.) may configure the different modification periods for part (e.g., a portion, a subset, a segment, etc.) of the system information. For example, the cell may configure the UE type and/or the network specific system information elements.

To achieve this purpose, in some embodiments, the cell may include information in the paging/short message, where the information may indicate (e.g., identify, define, etc.) which modification should and/or is adopted.

### 3.1 Configuring the Modification Period

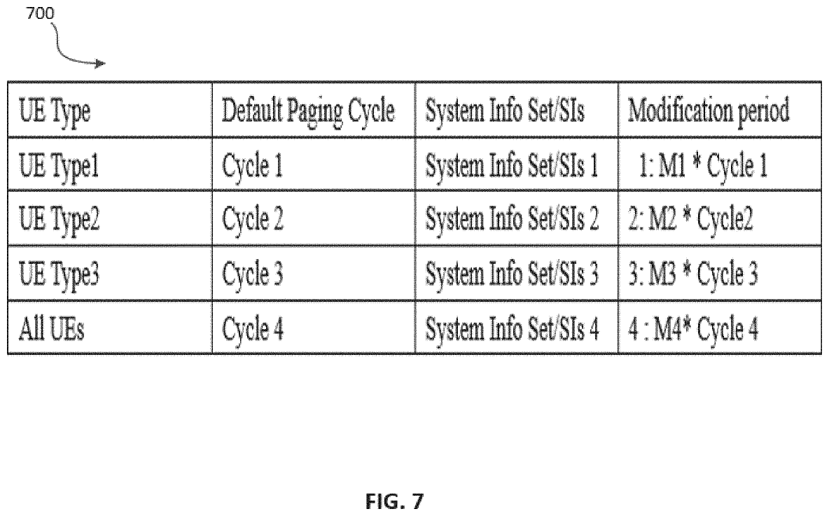

FIG. 7 illustrates an example table showing the modification period according to a UE type, a default paging cycle, and system information, in accordance with some embodiments of the present disclosure.

In some embodiments, the UE type may include a Network type. For example, the Network type may be a cell access group (CAG), a standalone Non-Public Network (SNPN), and/or a standalone PLMN.

In some embodiments, the UE type may include a Network identifier (ID). For example, the Network ID may be a PLMN, a Tracking Area Code (TAC), a CAG ID, and/or a SNPN ID.

In some embodiments, the UE type may include an Access category and/or an Access class. In some embodiments, the UE type may include a different beams and/or the corresponding CSI-RS resources. In some embodiments, the UE type may include different slices.

In some embodiments, the modification period may be configured by different M values with the same paging cycle, different cycles with the same M value, and/or different M values and/or cycles.

In some embodiments, at the UE side, the UE may take one or more modification periods. In some embodiments, the paging and/or the short massage (DCI) may indicate which modification period(s) should and/or is adopted explicitly or implicitly. In some embodiments, implicit adoption may mean that the UE determines the modification period based on a predefined criteria (e.g., a UE type).

### 3.2 Indicating the Modification Period

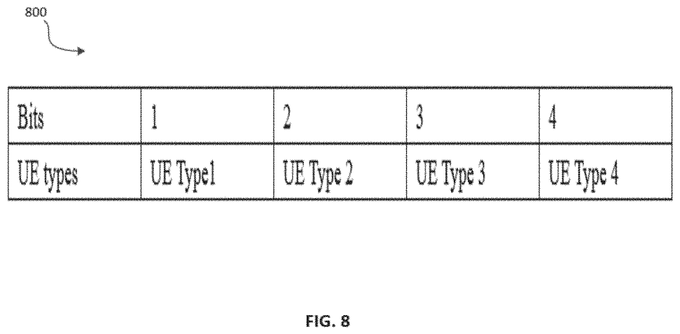

In some embodiments, if the system Information for UE type 1 changed, then the network can indicate the modification period explicitly or implicitly in the paging message. For example, FIG. 8 illustrates an example table showing the bits of a paging message, in accordance with some embodiments of the present disclosure. In the paging message, there are 4 bits starting from the left-most bit that indicate the 4 UE types respectively. For example, bit 1 may correspond to the UE Type 1, bit 2 may correspond to the UE Type 2, bit 3 may correspond to the UE Type 3, and bit 4 may correspond to the UE Type 4.

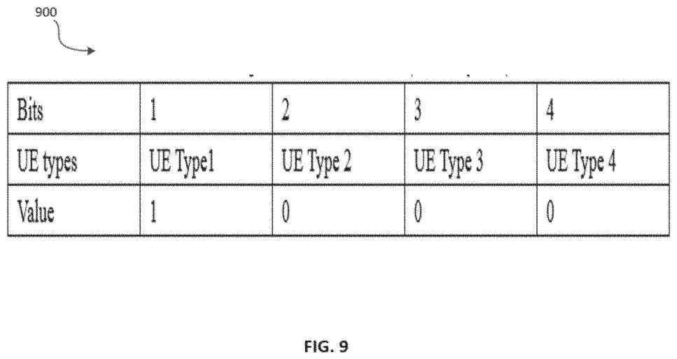

In some embodiments, once the UE detects the paging, then only the UE with type 1 will try to receive the system information at the next modification period with system frame number (SFN) mod (M1*Cycle 1)=0. For example, FIG. 9 illustrates an example table showing the bits of a paging message, in accordance with some embodiments of the present disclosure.

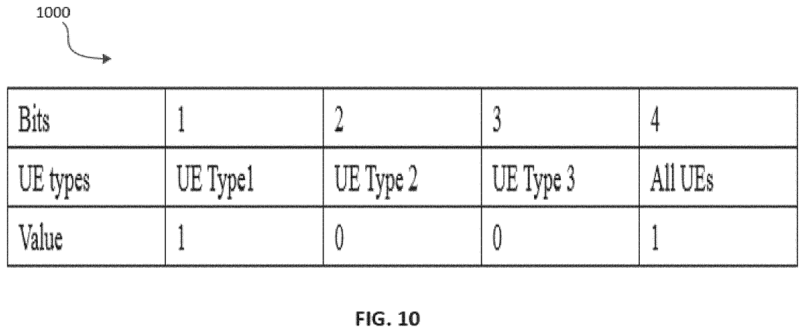

In some embodiments, if the bits for both the Type 1 UE and the “all UEs” were set to 1, then for the UE with Type 1 may receive the system information at the next modification period with SFN mod (M1*Cycle 1)32 0 and/or the system information at the another next modification period with SFN mod (M4*Cycle 4). For example, FIG. 10 illustrates an example table showing the bits of a paging message, in accordance with some embodiments of the present disclosure.

4. Determining a Radio Resource Configuration for one or more Device Types

The embodiments below describe how the network and/or customer may determine (e.g., identify, select, ascertain, etc.) a radio resource configuration (e.g., eDRX/DRX) for one or more device types. In some embodiments, the Public MNO who deployed the PNI-NPN can collect (e.g., gather, store, acquire, etc.) the UE related information according to the Customer's requirements. In some embodiments, the Customer can adjust (e.g., modify, configure, etc.) the configuration based on the UE related information (e.g. UE battery status). In some embodiments, the UE can log (e.g., store, record, etc.) its battery status in the minimization of drive test (MDT) data. In some embodiment, the customer can adjust the radio resource configuration (e.g., DRX/eDRX cycle) based on the statistic result.

In some embodiments, there can be one or more thresholds (e.g., predetermined value, etc.) for the UE to define a low, middle, and/or high battery status corresponding to the UE battery. In some embodiments, the UE can log and/or report (e.g., send, transmit, etc.) the battery status change event to the network through a logged MDT message. In some embodiments, a public network may apply the same method and/or embodiments, as discussed herein.

4.1 Configuring and/or Reporting a Change in Battery Status of a UE

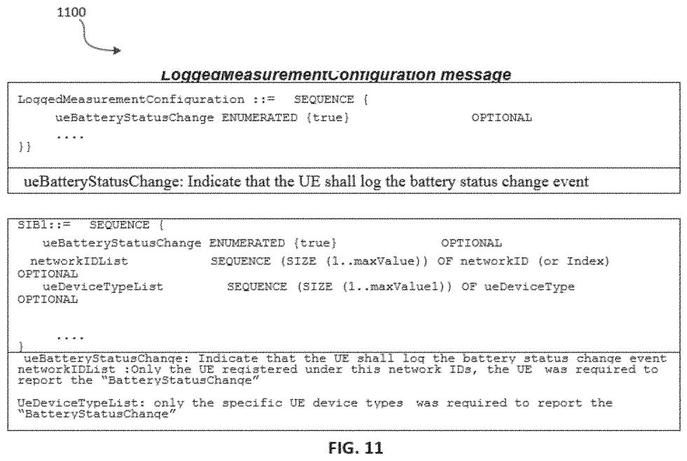

FIG. 11 illustrates an example structure for a LoggedMeasurementCofiguration message, in accordance with some embodiments of the present disclosure.

In some embodiments, responsive to receiving the radio resource configuration, the UE may store the received ueBatteryStatusChange configuration in the VarLogMeasConfig. In some embodiments, responsive to receiving the LoggedMeasurementConfiguration and/or detecting (e.g., determining, etc.) a battery status change event, the UE may store the received and/or detected information into a UE variable (e.g., VarLogMeasReport). In some embodiment, the UE variable includes the logged measurements information. In some embodiments, when the UE establishes the connection and/or handover from another RAT, the UE may indicate the battery change available information to the network through a message (e.g., an RRCResumeComplete/RRCSetupComplete/RestablishMentComplete/RRCReconfiguration Msg). In some embodiments, if the network includes battery information (e.g., battery InfoReq) in the UE information request message, then the UE may include the battery related information in a response message (e.g., a UEInformation Response message).

### 5. Reducing the Impact of the Reduced Capability UE due to a Change in System Information

The embodiments below describe how the network and/or customer may reduce the impact (e.g., a power savings) of the Reduced Capability UE when system information change.

In some embodiments, responsive to the network detecting a change in a radio resource configuration (e.g., DRX/eDRX cycle), the network may indicate the affected UE type in the DCI and/or the paging message to reduce the impact of the other type UEs.

### 5.1 Indicating the Affected UE Type

In some embodiments, the network and/or customer may indicate the affected UE type in the DCI and/or the paging message.

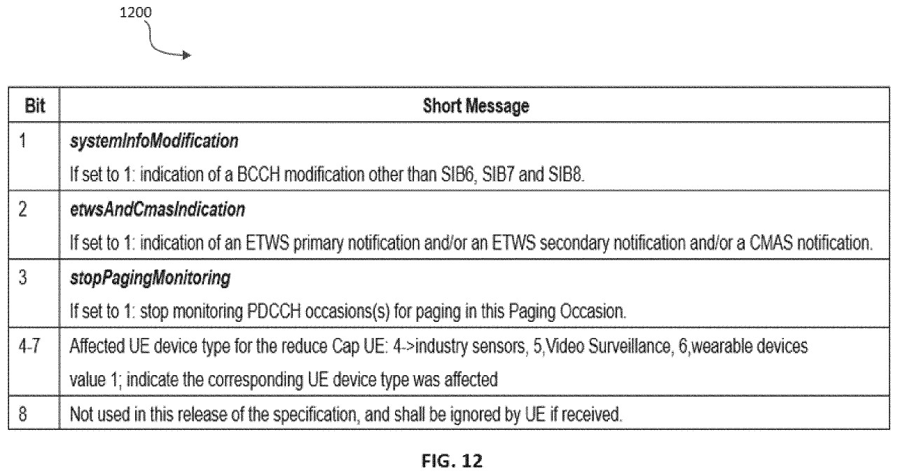

FIG. 12 illustrates an example structure for a short message for indicating the affected UE Types, in accordance with some embodiments of the present disclosure. As shown, the short message includes 8 bits. Bit 1 may correspond to systemInfoModification, which if set to 1, indicates a BCCH modification other than SIB6, SIB7 and SIB8. Bit 2 may correspond to etwsAndCmasIndication, which if set to 1, indicates an ETWS primary notification and/or an ETWS secondary notification and/or a CMAS notification. Bit 3 may correspond to stopPagingMonitoring, which if set to 1, indicates a stop monitoring PDCCH occasions(s) for paging in this Paging Occasion. Bits 4-7 may indicate an affected UE device type for the reduce Cap UE. That is, bit 4 may correspond to industry sensors, bit 5 may correspond to video surveillance, and/or bit 6 may correspond to wearable devices. In some embodiments, a bit having a value of 1, may indicate that the corresponding UE device type was affected by the change in system information. Bit 8, in some embodiments, may not be used and/or ignored by a UE if received.

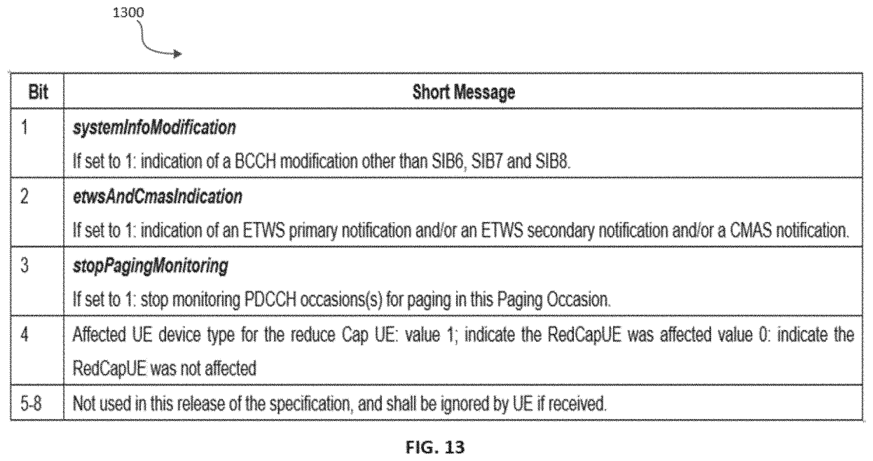

FIG. 13 illustrates an example structure for a short message for indicating the affected UE Types, in accordance with some embodiments of the present disclosure. As shown, the short message includes 8 bits. Bit 1 may correspond to systemInfoModification. Bit 2 corresponds to etwsAndCmasIndication. Bit 3 corresponds to stopPagingMonitoring. Bits 4-7 indicate an affected UE device type for the reduce Cap UE. In some embodiments, a bit having a value of 1, indicates that the RedCapUE was affected by the change in system information. In some embodiments, a bit having a value of 0, indicates that the RedCapUE was not affected by the change in system information. Bit 8, in some embodiments, may not be used and/or ignored by a UE if received.

### 6. Methods for Implementing the Exemplary Embodiments

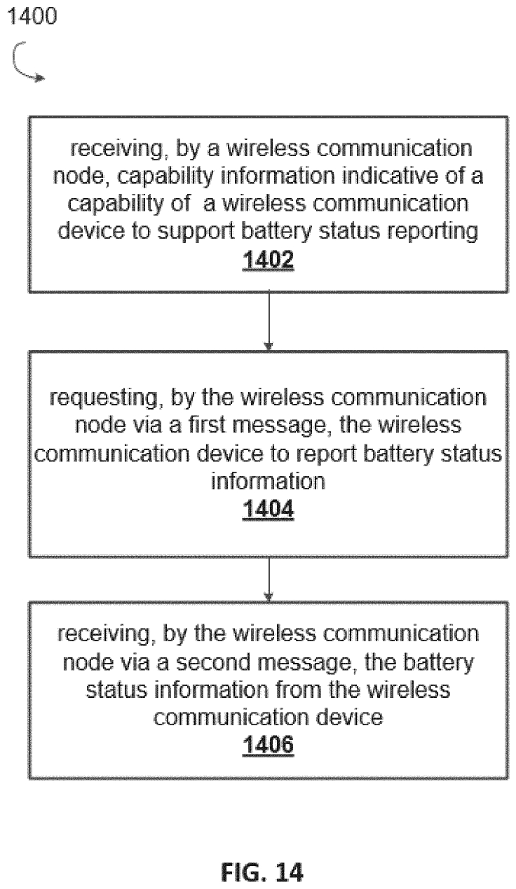

FIG. 14 is a flow diagram depicting a method for configuring a radio resource configuration for different types of Reduced Capability UE in order to achieve different power saving requirements. Additional, fewer, or different operations may be performed in the method depending on the particular embodiment. In some embodiments, some or all operations of method 1400 may be performed by a wireless communication node, such as BS 102 in FIG. 1. In some operations, some or all operations of method 1400 may be performed by a wireless communication device, such as UE 104 in FIG. 1. Each operation may be re-ordered, added, removed, or repeated.

As shown, the method 1400 includes, in some embodiments, the operation 1402 of receiving, by a wireless communication node, capability information indicative of a capability of a wireless communication device to support battery status reporting. The method includes, in some embodiments, the operation 1404 of requesting, by the wireless communication node via a first message, the wireless communication device to report battery status information. The method includes, in some embodiments, the operation 1406 of receiving, by the wireless communication node via a second message, the battery status information from the wireless communication device.

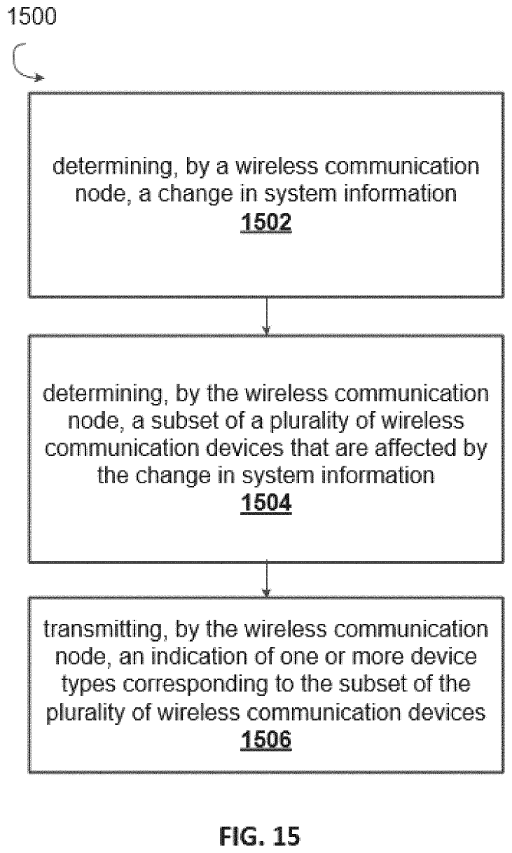

FIG. 15 is a flow diagram depicting a method for configuring a radio resource configuration for different types of Reduced Capability UE in order to achieve different power saving requirements. Additional, fewer, or different operations may be performed in the method depending on the particular embodiment. In some embodiments, some or all operations of method 1300 may be performed by a wireless communication node, such as BS 102 in FIG. 1. In some operations, some or all operations of method 1500 may be performed by a wireless communication device, such as UE 104 in FIG. 1. Each operation may be re-ordered, added, removed, or repeated.

As shown, the method 1500 includes, in some embodiments, the operation 1502 of determining, by a wireless communication node, a change in system information. The method includes, in some embodiments, the operation 1504 of determining, by the wireless communication node, a subset of a plurality of wireless communication devices that are affected by the change in system information. The method includes, in some embodiments, the operation 1506 of transmitting, by the wireless communication node, an indication of one or more device types corresponding to the subset of the plurality of wireless communication devices.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
transmitting, by a wireless communication node, a signal to a plurality of wireless communication devices of different device types,
wherein the signal comprises a plurality of associations between a plurality of device types and a plurality of network types, each association of the plurality of associations is indicative of a radio resource configuration for a respective device type of the plurality of device types.

2. The method of claim 1, wherein the radio resource configuration includes a physical channel configuration, a reference signal configuration, or a logical channel configuration.

3. The method of claim 2, wherein the logical channel configuration includes a broadcast channel, a paging channel, a control channel, or a data channel configuration.

4. The method of claim 1, wherein the wireless communication node broadcasts the signal to the plurality of wireless communication devices via a system information signal or a radio resource control (RRC) signal.

5. The method of claim 1, wherein an association of the plurality of associations corresponds to a public land mobile network (PLMN) and a non-public network.

6. The method of claim 5, wherein the non-public network includes at least one of a standalone non-public network (SNPN) or a public integrated non-public network (PNI-NPN).

7. The method of claim 1, wherein the device type corresponds to an industry sensor, a video surveillance, or a wearable device.

8. The method of claim 1, further comprising:
configuring, by the wireless communication node, different paging cycles for the plurality of wireless communication devices based on at least one of the plurality of device types or the plurality of network types.

9. The method of claim 1, further comprising:
configuring, by the wireless communication node, different modification periods for the system information change.

10. The method of claim 1, further comprising:
configuring, by the wireless communication node, different modification periods for different system information elements groups based on at least one of different network types, different network identifiers, different access categories, different access classes, different beams or the corresponding channel status information-reference signal (CSI-RS) resources, different slices, or device types,
wherein the different network types correspond to at least one of a cell access group (CAG), a standalone Non-Public Network (SNPN), or a standalone public land mobile network (PLMN),
wherein the different network identifiers correspond to at least one of a PLMN, a Tracking Area Code (TAC), a CAG identifier, or a SNPN identifier, and
wherein the device types correspond to at least one of an industry sensor, a video surveillance, or a wearable device.

11. The method of claim 1, further comprising:
configuring, by the wireless communication node, different modification periods for different system information elements groups, wherein the different modification periods are configured based on different M values of a same paging cycle, different paging cycles of a same M value, or different M values of different paging cycles.

12. The method of claim 11, wherein an M value corresponds to a coefficient of a modification period of the different modification periods, wherein the modification period corresponds to M*PagingCycle.

13. The method of claim 9, further comprising:
indicating, by the wireless communication node, modification period information in a paging message, wherein the modification period information indicative of one or more modification periods to adopt.

14. The method of claim 13, wherein a wireless communication device of the plurality of wireless communication devices determines the modification period based on a device type.

15. The method of claim 14, wherein the wireless communication device of the plurality of wireless communication devices: receives a paging message comprising a bitmap indicative of affected device types, and determines the modification period based on the affected device types.

16. The method of claim 9, further comprising:
transmitting, by the wireless communication node, a paging message indicative of one or more modification periods.

17. A method comprising:
receiving, by a wireless communication device, a signal from a wireless communication node, wherein the signal comprises a plurality of associations between a plurality of device types and a plurality of network types, each association of the plurality of associations is indicative of a radio resource configuration for a respective device type of the plurality of device types, wherein the signal is broadcasted to a plurality of wireless communication devices of different device types.

18. The method of claim 17, wherein the radio resource configuration includes a physical channel configuration, a reference signal configuration, or a logical channel configuration.

19. A wireless communication node, comprising:
at least one processor configured to:
transmit, via a transmitter, a signal to a plurality of wireless communication devices of different device types,
wherein the signal comprises a plurality of associations between a plurality of device types and a plurality of network types, each association of the plurality of associations is indicative of a radio resource configuration for a respective device type of the plurality of device types.

20. A wireless communication device, comprising:
at least one processor configured to:
receive, via a receiver, a signal from a wireless communication node, wherein the signal comprises a plurality of associations between a plurality of device types and a plurality of network types, each association of the plurality of associations is indicative of a radio resource configuration for a respective device type of the plurality of device types,
wherein the signal is broadcasted to a plurality of wireless communication devices of different device types.
